(19) United States
(12) Patent Application Publication
(10) Pub. No.: US 2022/0163708 A1
(43) Pub. Date: May 26, 2022

(54) RETROREFLECTIVE SHEETING

(71) Applicants: NIPPON CARBIDE INDUSTRIES CO., INC., Tokyo (JP); HAYASHI TELEMPU CORPORATION, Nagoya (JP)

(72) Inventors: Taketoshi Hayashi, Tokyo (JP); Arito Kurobe, Nagoya (JP)

(73) Assignees: NIPPON CARBIDE INDUSTRIES CO., INC., Tokyo (JP); HAYASHI TELEMPU CORPORATION, Nagoya (JP)

(21) Appl. No.: 17/527,701

(22) Filed: Nov. 16, 2021

(30) Foreign Application Priority Data
Nov. 24, 2020 (JP) 2020-194608

(51) Int. Cl. G02B 5/13

(52) U.S. Cl. CPC G02B 5/13

(57) ABSTRACT

A retroreflective sheeting includes: a retroreflective layer that retroreflects light incident on one surface; a light transmissive transparent colored layer provided to face the one surface of the retroreflective layer; and a light non-transmissive opaque layer provided on a side of the transparent colored layer with reference to the one surface of the retroreflective layer, in which the transparent colored layer has a region that is in contact with the opaque layer and does not overlap the opaque layer when the retroreflective layer is viewed in a plan view, and a hue of the region of the transparent colored layer is equivalent to a hue of a region of the opaque layer in contact with the region.

### BACKGROUND ART

The present invention relates to a retroreflective sheeting.

A retroreflective sheeting having a property of reflecting incident light in an incident direction is known. For example, Patent Literature 1 below discloses a retroreflective sheeting including a retroreflective layer that retroreflects light incident on one surface, a surface protective layer provided to face the one surface, and a printed layer provided between the retroreflective layer and the surface protective layer. According to such a retroreflective sheeting, a display pattern of characters, figures, and the like represented by the printed layer can be directly and visually recognized under a diffused light condition such as daytime, and the display pattern can be visually recognized by light retroreflected by the retroreflective layer even in a dark place such as nighttime.
[Patent Literature 1] JP 2002-149095 A

### SUMMARY OF INVENTION

In recent years, from the viewpoint of designability and the like, there is a demand for making a display pattern visible under a diffused light condition such as daytime different from a display pattern visible under a retroreflective condition such as nighttime.

Therefore, an object of the present invention is to provide a retroreflective sheeting in which a visible display pattern can be made different between under a diffused light condition and under a retroreflective condition.

In order to achieve the above object, a retroreflective sheeting according to the present invention includes: a retroreflective layer that retroreflects light incident on one surface; a light transmissive transparent colored layer provided to face the one surface of the retroreflective layer; and a light non-transmissive opaque layer provided on a side of the transparent colored layer with reference to the one surface of the retroreflective layer, in which the transparent colored layer has a region that is in contact with the opaque layer and does not overlap the opaque layer when the retroreflective layer is viewed in a plan view, and a hue of the region of the transparent colored layer is equivalent to a hue of a region of the opaque layer in contact with the region.

In this retroreflective sheeting, since the hue of the region of the transparent colored layer is equivalent to the hue of the region of the opaque layer, a boundary between the region of the transparent colored layer and the region of the opaque layer can be made difficult to be visually recognized under a diffused light condition such as daytime, so that the region of the transparent colored layer and the region of the opaque layer appear as if they are integrated. On the other hand, when the retroreflective sheeting is irradiated with light under a retroreflective condition such as nighttime, the light incident on the region of the transparent colored layer is retroreflected by the retroreflective layer and emitted from the retroreflective sheeting. Most of the light incident on the opaque layer is blocked by the opaque layer and is not incident on the retroreflective layer, is absorbed by the opaque layer or is diffusely reflected by the opaque layer, and is hardly retroreflected. Therefore, the region of the opaque layer can be made to appear darker than the region of the transparent colored layer, and the boundary between the region of the transparent colored layer and the region of the opaque layer can be made visually recognized. Therefore, according to this retroreflective sheeting, the visible display pattern represented by the transparent colored layer and the opaque layer can be made different between under the retroreflective condition and under the diffused light condition.

A color difference between a color of the region of the transparent colored layer and a color of the region of the opaque layer represented by a color difference according to an L*a*b* color system defined in JIS 28730 is preferably equal to or less than 3.0, and more preferably equal to or less than 2.0.

A retroreflective sheeting according to the present invention includes: a retroreflective layer that retroreflects light incident on one surface; and a light non-transmissive opaque layer provided to face the one surface of the retroreflective layer, in which the retroreflective layer has a region that is in contact with the opaque layer and does not overlap the opaque layer when the retroreflective layer is viewed in a plan view, and a hue of the region of the retroreflective layer is equivalent to a hue of a region of the opaque layer in contact with the region.

In this retroreflective sheeting, since the hue of the region of the retroreflective layer is equivalent to the hue of the region of the opaque layer, a boundary between the region of the retroreflective layer and the region of the opaque layer can be made difficult to be visually recognized under a diffused light condition such as daytime, so that the region of the retroreflective layer and the region of the opaque layer appear as if they are integrated. On the other hand, when the retroreflective sheeting is irradiated with light under a retroreflective condition such as nighttime, the light incident on the region of the retroreflective layer is retroreflected and emitted from the retroreflective sheeting. Most of the light incident on the opaque layer is blocked by the opaque layer and is not incident on the retroreflective layer, and is hardly retroreflected. Therefore, the region of the opaque layer can be made to appear darker than the region of the retroreflective layer, and the boundary between the region of the retroreflective layer and the region of the opaque layer can be made visually recognized. Therefore, according to this retroreflective sheeting, the visible display pattern represented by the retroreflective layer and the opaque layer can be made different between under the retroreflective condition and under the diffused light condition.

A color difference between a color of the region of the retroreflective layer and a color of the region of the opaque layer represented by a color difference according to an L*a*b* color system defined in JIS 28730 is preferably equal to or less than 3.0, and more preferably equal to or less than 2.0.

In the above-described retroreflective sheeting in which the hue of the region of the transparent colored layer is equivalent to the hue of the region of the opaque layer, and the above-described retroreflective sheeting in which the hue of the region of the retroreflective layer is equivalent to the hue of the region of the opaque layer, the opaque layer may include at least a light diffusing agent exposed to the side opposite to the side of the retroreflective layer in the region.

With such a configuration, light incident on the region of the opaque layer is diffused by the light diffusing agent. Therefore, as compared with the case where the opaque layer does not include the light diffusing agent, the region of the opaque layer can be made to appear darker under a retroreflective condition such as nighttime, and the contrast between the region of the opaque layer and the region of the transparent colored layer and the contrast between the region of the opaque layer and the region of the retroreflective layer can be made large.

As described above, according to the present invention, it is possible to provide a retroreflective sheeting in which a visible display pattern can be made different between under a diffuse light condition and under a retroreflective condition.

### BRIEF DESCRIPTION OF DRAWINGS

FIG. 1 is a diagram schematically illustrating a cross section of a retroreflective sheeting according to a first embodiment of the present invention;

FIG. 2 is an exploded view illustrating a configuration of the retroreflective sheeting in FIG. 1;

FIG. 3 is a diagram for explaining a positional relationship between a transparent colored layer and an opaque layer;

FIG. 4 is a diagram schematically illustrating a display pattern projected on the retroreflective sheeting under a diffused light condition;

FIG. 5 is a diagram schematically illustrating a display pattern projected on the retroreflective sheeting when the retroreflective sheeting is irradiated with light under a retroreflective condition;

FIG. 6 is a diagram schematically illustrating a cross section of a retroreflective sheeting according to a second embodiment of the present invention;

FIG. 7 is a diagram schematically illustrating a cross section of a retroreflective sheeting according to a third embodiment of the present invention;

FIG. 8 is a view illustrating the retroreflective layer and the opaque layer in a direction in which one surface of the retroreflective layer is viewed in a plan view; and

FIG. 9 is a diagram schematically illustrating a cross section of a retroreflective sheeting according to a modification.

### DESCRIPTION OF EMBODIMENTS

Hereinafter, embodiments for implementing a retroreflective sheeting according to the present invention will be exemplified with reference to the accompanying drawings. The embodiments exemplified below are for the purpose of facilitating the understanding of the present invention, and are not intended to limit the present invention. The present invention can be modified and improved from the following embodiments without departing from the gist thereof. In the drawings referred to below, dimensions of each member may be changed for easy understanding.

### First Embodiment

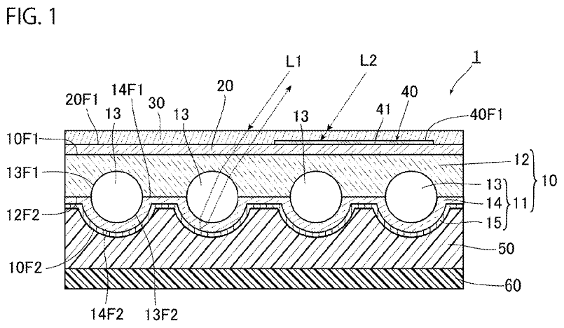

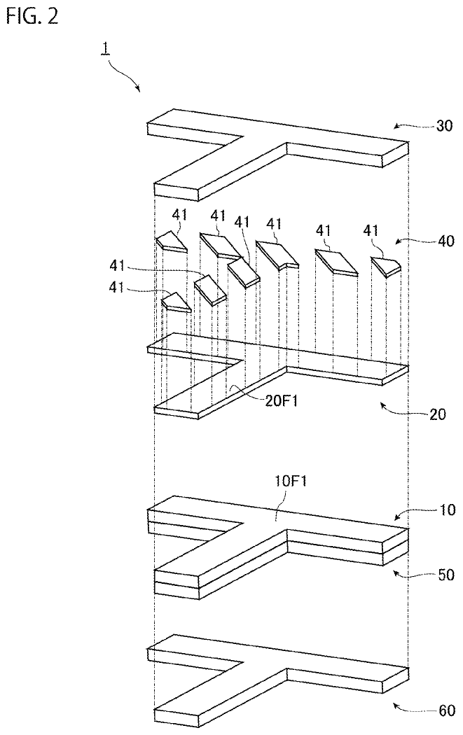

FIG. 1 is a diagram schematically illustrating a cross section of a retroreflective sheeting according to a first embodiment of the present invention, and FIG. 2 is an exploded view illustrating a configuration of the retroreflective sheeting in FIG. 1. As illustrated in FIGS. and 2, a retroreflective sheeting 1 according to the present embodiment includes a surface protective layer 30, an opaque layer 40, a transparent colored layer 20, a retroreflective layer 10, and an adhesive layer 50 as main components, and has a configuration in which the plurality of layers 30, 40, 20, 10, 50 are stacked. The outer shape of the retroreflective sheeting 1 in a plan view is substantially T-shaped, but is not limited. In FIG. 2, the adhesive layer 50 is stacked on the retroreflective layer 10.

As illustrated in FIG. 1, the retroreflective layer 10 in the present embodiment is a so-called enclosed lens type retroreflective layer, and is configured to retroreflect light incident on one surface 10F1. The outer shape of the retroreflective layer 10 of the present embodiment in a plan view is substantially T-shaped. The retroreflective layer 10 includes a retroreflective element layer 11 and a light transmissive holding body layer 12 that holds the retroreflective element layer 11. One surface of the holding body layer 12 is one surface 10F1 of the retroreflective layer 10, and the retroreflective element layer 11 is provided on the other surface 12F2 of the holding body layer 12. The holding body layer 12 of the present embodiment is substantially colorless and transparent. The material of the holding body layer 12 is preferably a material excellent in light transmittance. Examples of the material having excellent light transmittance include a polycarbonate-based resin, a vinyl chloride-based resin, a vinylidene fluoride-based resin, an acrylic-based resin, an epoxy-based resin, a styrene-based resin, a polyester-based resin, a fluorine-based resin, a polyethylene-based resin, an olefin-based resin, a cellulose-based resin, and a urethane-based resin.

The retroreflective element layer 11 includes a plurality of fine glass spheres 13 as retroreflective elements, a focus forming layer 14, and a specular reflection layer 15. The plurality of fine glass spheres 13 have, for example, a particle diameter of preferably 20 μm to 150 μm, more preferably 30 μm to 120 μm, still more preferably 50 μm to 100 μm, and are arranged at predetermined intervals. The substantially upper half of each of the fine glass spheres 13 is enclosed inside the holding body layer 12 from the surface 12F2 of the holding body layer 12, so that the plurality of fine glass spheres 13 are held in the holding body layer 12. The fine glass sphere 13 of the present embodiment is substantially colorless and transparent.

The focus forming layer 14 is a light transmissive layer for arranging the specular reflection layer 15 described later at the focal position of the fine glass sphere 13. The focus forming layer 14 covers the surface 12F2 of the holding body layer 12 and the hemispherical surface 13F2 of the fine glass sphere 13 that is not enclosed in the holding body layer 12. The focus forming layer 14 of the present embodiment is substantially colorless and transparent. As a material of the focus forming layer 14, in general, a resin such as an acrylic resin, an alkyd resin, a fluororesin, a vinyl chloride resin, a polyester resin, a urethane resin, a polycarbonate resin, or a butyral resin is used alone or in combination, but an acrylic resin is preferably used from the viewpoint of weather resistance, coating suitability, and thermal stability.

The specular reflection layer 15 is a layer for reflecting light transmitted through the fine glass sphere 13. In the present embodiment, the specular reflection layer 15 is formed over the entire surface of the surface 14F2 opposite to the holding body layer 12 side of the focus forming layer 14, and is arranged at the focal position of each fine glass sphere 13 by the focus forming layer 14 as described above. The specular reflection layer 15 is formed by means such as a vacuum vapor deposition method or a sputtering method using a metal having excellent reflectivity such as aluminum, copper, silver, or nickel. The maximum thickness of the specular reflection layer 15 may be, for example, 0.1 μm.

In the retroreflective element layer 11 configured as described above, in the cross-sectional view of FIG. 1, a surface including the surface 14F1 of the focus forming layer 14 and the hemispherical surface 13F1 of the fine glass sphere 13 enclosed in the holding body layer 12 is one surface of the retroreflective element layer 11. A surface of the specular reflection layer 15 on a side opposite to the focus forming layer 14 side is the other surface of the retroreflective element layer 11, and this surface is the other surface 10F2 of the retroreflective layer 10.

The adhesive layer 50 of the present embodiment is formed over the entire surface of the other surface 10F2 of the retroreflective layer 10 on the side opposite to the side of the focus forming layer 14 of the specular reflection layer 15. Examples of the material of the adhesive layer 50 include an acrylic resin, an epoxy resin, a phenol resin, a vinyl acetate resin, a nitrile rubber resin, and a silicone rubber resin. The maximum thickness of the adhesive layer 50 may be, for example, 70 μm.

When the retroreflective sheeting 1 is not in use, a peeling layer 60 is stacked on the other surface of the adhesive layer 50 opposite to the one surface facing the specular reflection layer 15 to prevent dust and the like from adhering to the adhesive layer 50. On the other hand, when the retroreflective sheeting 1 is in use, the peeling layer 60 is peeled off from the adhesive layer 50. The maximum thickness of the peeling layer 60 may be, for example, 75 μm.

The transparent colored layer 20 is a layer provided so as to face the one surface 10F1 of the retroreflective layer 10, and is a light transmissive layer that transmits visible light. In the present embodiment, the transparent colored layer 20 is formed over the entire surface of the one surface 10F1 of the retroreflective layer 10, and the outer shape of the transparent colored layer 20 in plan view is the same shape as that of the retroreflective layer 10. In the present embodiment, the entire transparent colored layer 20 is red, but the color of the transparent colored layer 20 is not limited. The transparent colored layer 20 may be formed on a part of the one surface 10F1 of the retroreflective layer 10. In the present specification, the transparent colored layer 20 having the light transmissive property means that, for example, the transmittance of light of substantially the same color as the transparent colored layer 20 is equal to or greater than 60%.

The transparent colored layer 20 is preferably formed by, for example, printing using a light transmissive resin ink by a gravure printing method, a screen printing method, a flexographic printing method, an inkjet printing method, or the like. However, the transparent colored layer 20 is not limited to one formed by printing, and may be formed of, for example, a light transmissive resin film. The maximum thickness of the transparent colored layer 20 may be, for example, 10 μm.

The opaque layer 40 is a layer provided on the transparent colored layer 20 side with respect to the one surface 10F1 of the retroreflective layer 10, and is a light non-transmissive layer that does not transmit visible light. In the present embodiment, as illustrated in FIG. 2, the opaque layer 40 includes a plurality of band-shaped portions 41 provided on the surface 20F1 of the transparent colored layer 20 on the side opposite to the retroreflective layer side. The plurality of band-shaped portions 41 are arranged such that a stripe pattern is formed when the opaque layer 40 is viewed in a plan view. The pattern of the opaque layer 40 in plan view is not limited. For example, the opaque layer 40 may be formed to represent characters and figures, and the number of characters and figures represented by the opaque layer 40 is not limited. The hue of the opaque layer 40 is equivalent to the hue of the transparent colored layer 20. In the present specification, the opaque layer 40 having the light non-transmissive property indicates, for example, that transmittance of visible light is equal to or less than 30%.

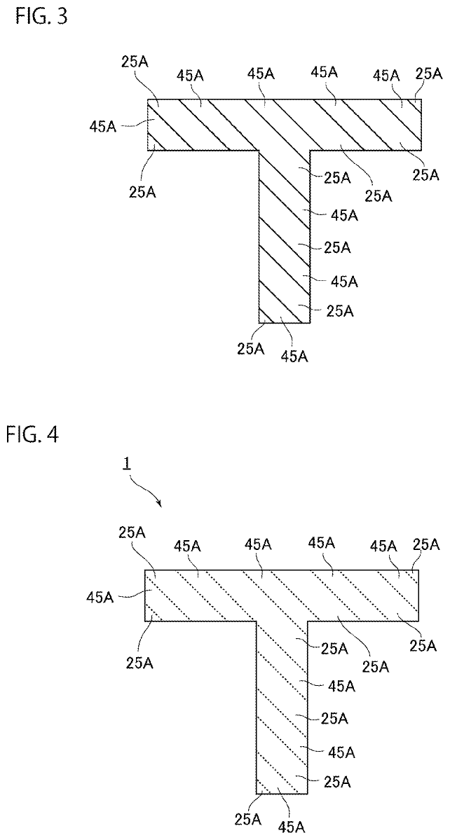

FIG. 3 is a diagram for explaining a positional relationship between the transparent colored layer 20 and the opaque layer 40, and is a diagram of the transparent colored layer 20 and the opaque layer 40 viewed from a direction in which one surface 10F1 of the retroreflective layer 10 is viewed in a plan view. As illustrated in FIG. 3, when viewed in this manner, the transparent colored layer 20 has a region 25A that does not overlap the plurality of band-shaped portions 41 constituting the opaque layer 40, and this region 25A is in contact with a region 45A corresponding to the band-shaped portion 41. As described above, since the hue of the opaque layer 40 is equivalent to the hue of the transparent colored layer 20, the hues of the region 25A and the region 45A are equal. In the present embodiment, when viewed in this manner, the entire region 45A overlaps the transparent colored layer 20, and a part of the outer edge of each region 45A overlaps a part of the outer edge of the transparent colored layer 20, and the other part overlaps other than the outer edge of the transparent colored layer 20. The transparent colored layer 20 has another region overlapping the region 45A of the opaque layer 40, and the hue of the another region is also equivalent to the hue of the region 45A.

The opaque layer 40 is preferably formed by, for example, printing using a resin ink having a light non-transmissive property by a gravure printing method, a screen printing method, a flexographic printing method, an inkjet printing method, or the like. However, the opaque layer 40 is not limited to one formed by printing, and may be formed of, for example, a resin film having a light non-transmissive property. The maximum thickness of the opaque layer 40 may be, for example, 10 μm.

The opaque layer 40 of the present embodiment includes a light diffusing agent that diffuses incident light, and the light diffusing agent is exposed at least to the side opposite to the retroreflective layer 10 side. Examples of such a light diffusing agent include resin particles made of a melamine resin, a benzoguanamine resin, or the like, or inorganic particles made of calcium carbonate, silica, magnesium carbonate, talc, aluminum hydroxide, alumina, zirconia, titania, barium sulfate, hydrotalcites, or the like. The volume median diameter of the light diffusing agent is preferably 1 μm to 10 μm, and more preferably 1 μm to 5 μm. The opaque layer 40 may not contain the light diffusing agent.

The surface protective layer 30 of the present embodiment is a light transmissive layer that covers the entire surface of the surface 40F1 of the opaque layer 40 on the side opposite to the transparent colored layer 20 and the entire surface of a portion of the surface 20F1 of the transparent colored layer 20 where the opaque layer 40 is not provided. The outer shape of the surface protective layer 30 in plan view is the same as that of the retroreflective layer 10, and the opaque layer 40 is sandwiched between the surface protective layer 30 and the transparent colored layer 20. Examples of the material of the surface protective layer 30 include similar materials to those of the holding body layer 12. The surface protective layer 30 is a layer on a side on which light is incident from the outside of the retroreflective sheeting 1.

As described above, the retroreflective sheeting 1 according to the present embodiment includes the retroreflective layer 10 that retroreflects light incident on the one surface 10F1, the light transmissive transparent colored layer 20 provided to face the one surface 10F1 of the retroreflective layer 10, and the light transmissive opaque layer 40 provided on the transparent colored layer 20 side with respect to the one surface 10F1 of the retroreflective layer 10. The transparent colored layer 20 has a region 25A that is in contact with the opaque layer 40 and does not overlap the opaque layer 40 when the retroreflective layer 10 is viewed in a plan view.

The hue of the region 25A of the transparent colored layer 20 is equivalent to the hue of the region 45A of the opaque layer 40 in contact with the region 25A. For this reason, as illustrated in FIG. 4, under the diffused light condition such as daytime, the boundary between the region 25A of the transparent colored layer 20 and the region 45A of the opaque layer 40 becomes difficult to be visually recognized, and the region 25A of the transparent colored layer 20 and the region 45A of the opaque layer 40 can be made to be viewed as if they are integrated. FIG. 4 is a diagram schematically illustrating a display pattern projected on the retroreflective sheeting 1 under the diffused light condition such as daytime, and a boundary between the region 25A and the region 45A is indicated by a dotted line. In the present embodiment, since the color of the transparent colored layer 20 is red and the entire opaque layer 40 and the transparent colored layer 20 overlap each other, a display pattern in which the entire area is red is projected on the retroreflective sheeting 1.

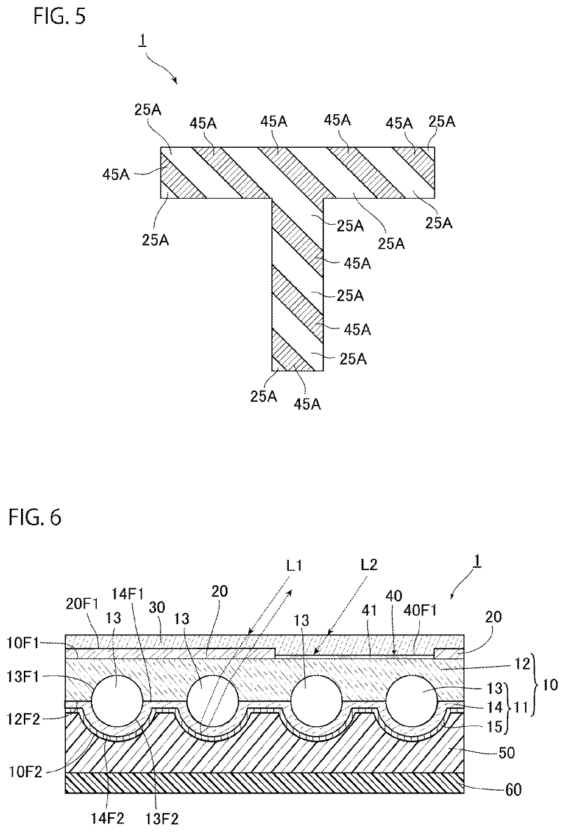

On the other hand, when the retroreflective sheeting 1 is irradiated with light under the retroreflective condition such as nighttime, as illustrated in FIG. 1, part of the light passes through the surface protective layer 30 and enters the region 25A of the transparent colored layer 20, and the other part of the light passes through the surface protective layer 30 and is incident on the opaque layer 40. Most of the light L1 incident on the region 25A is transmitted through the transparent colored layer 20 to be incident on the surface 10F1 of the retroreflective layer 10, and is transmitted through the holding body layer 12, the fine glass spheres 13, and the focus forming layer 14 to be retroreflected on the surface of the specular reflection layer 15 on the side of the focus forming layer 14. The retroreflected light L1 is transmitted through the transparent colored layer 20 and the surface protective layer 30 and emitted from the retroreflective sheeting 1. Since the transparent colored layer 20 is red, red light out of the light L1 is emitted from the retroreflective sheeting 1. Most of the light L2 incident on the opaque layer 40 is blocked by the opaque layer 40 and is not incident on the retroreflective layer 10, and is absorbed by the opaque layer or reflected by the opaque layer 40, and is hardly retroreflected. Therefore, when the retroreflective sheeting is irradiated with light under the retroreflective condition such as nighttime, as illustrated in FIG. 5, the region 25A of the transparent colored layer 20 emits red light, and the region 45A of the opaque layer 40 does not emit light. FIG. 5 is a diagram schematically illustrating a display pattern projected on the retroreflective sheeting 1 when the retroreflective sheeting 1 is irradiated with light under the retroreflective condition such as nighttime, and the region 45A is hatched. As described above, the region 45A of the opaque layer 40 can be made to appear darker than the region 25A of the transparent colored layer 20, and the boundary between the region 25A of the transparent colored layer 20 and the region 45A of the opaque layer 40 can be made visible. Therefore, according to the retroreflective sheeting 1 of the present embodiment, the visible display pattern represented by the transparent colored layer 20 and the opaque layer 40 can be made different between under the retroreflective condition and under the diffused light condition.

In the present embodiment, since the opaque layer 40 includes the light diffusing agent exposed at least to the side opposite to the retroreflective layer 10 side, the light L2 incident on the opaque layer 40 is diffused by the light diffusing agent. Therefore, as compared with the case where the opaque layer 40 does not include the light diffusing agent, the region 45A of the opaque layer 40 can be made to appear darker under the retroreflective condition such as nighttime, and the contrast between the region 45A of the opaque layer 40 and the region 25A of the transparent colored layer 20 can be made large.

The color difference between the region 25A of the transparent colored layer 20 and the region 45A of the opaque layer 40 is preferably equal to or less than 3.0, more preferably equal to or less than 2.0 when expressed by a color difference according to an L*a*b* color system defined in JIS 28730. As a result, the boundary between the region 25A of the transparent colored layer 20 and the region 45A of the opaque layer 40 can be made more difficult to visually recognize under the diffused light condition such as daytime.

The brightness of the region 25A of the transparent colored layer 20 and the region 45A of the opaque layer 40 may be equal to or less than 30 when expressed by the brightness according to the L*a*b* color system defined in JIS 28730. When the retroreflective sheeting 1 is irradiated with light under the retroreflective condition, as described above, the region 25A of the transparent colored layer 20 emits light to brighten the portion. Therefore, by setting the brightness to equal to or less than 30, the difference between the display pattern under the retroreflective condition and the display pattern under the diffused light condition felt by the viewer can be made remarkable.

### Second Embodiment

Next, a second embodiment of the present invention will be described with reference to FIG. 6. Note that the same or equivalent constituent elements as those of the first embodiment are denoted by the same reference numerals, and redundant explanation may be omitted except when particularly described.

FIG. 6 is a diagram schematically illustrating a cross section of the retroreflective sheeting 1 according to a second embodiment of the present invention. As illustrated in FIG. 6, the retroreflective sheeting 1 according to the present embodiment is different from the retroreflective sheeting 1 according to the first embodiment in that the transparent colored layer 20 and the opaque layer 40 are arranged side by side on one surface 10F1 of the retroreflective layer 10. Therefore, in the present embodiment, the layers are stacked in the order of the surface protective layer 30, the transparent colored layer 20, the opaque layer 40, the retroreflective layer 10, and the adhesive layer 50. Hereinafter, the retroreflective sheeting 1 according to the present embodiment will be described.

In the present embodiment, the opaque layer 40 is provided on one surface 10F1 of the retroreflective layer 10, and includes a plurality of band-shaped portions 41 such that a pattern in plan view has a stripe pattern, as in the first embodiment. The transparent colored layer 20 is provided so as to cover the entire portion of the one surface 10F1 of the retroreflective layer 10 where the band-shaped portion 41 is not provided. Thus, the transparent colored layer 20 is composed of a plurality of portions, and the end of each portion is in contact with the end of the band-shaped portion 41. When the transparent colored layer 20 and the opaque layer 40 are viewed from a direction in which the one surface 10F1 of the retroreflective layer 10 is viewed in a plan view, they appear as similar to those in the first embodiment, and as illustrated in FIG. 3. Therefore, as similar to the first embodiment, when the retroreflective layer 10 is viewed in a plan view, the transparent colored layer 20 has a region 25A that does not overlap the plurality of band-shaped portions 41 constituting the opaque layer 40, and this region 25A is in contact with the region 45A corresponding to the band-shaped portion 41. In the present embodiment, the hue of the entire transparent colored layer is equivalent to the hue of the opaque layer 40. Therefore, the hue of the region 25A is equal to that of the region 45A. In the present embodiment, when viewed in this manner, the entire region 45A does not overlap the transparent colored layer 20, and the transparent colored layer 20 does not overlap the region 45A. The surface protective layer 30 of the present embodiment covers the entire surface of the surface 20F1 of the transparent colored layer 20 on the side opposite to the retroreflective layer 10 side and the entire surface of the surface 40F1 of the opaque layer 40 including the plurality of band-shaped portions 41.

In the retroreflective sheeting 1 according to the present embodiment, as in the first embodiment, the transparent colored layer 20 has a region 25A that is in contact with the opaque layer 40 and does not overlap the opaque layer 40 when the retroreflective layer 10 is viewed in a plan view, and the hue of the region 25A of the transparent colored layer 20 is equivalent to the hue of the region 45A of the opaque layer 40 in contact with the region 25A. Therefore, according to the retroreflective sheeting of the present embodiment, as similar to the first embodiment, the visible display pattern represented by the transparent colored layer 20 and the opaque layer 40 can be made different between under the retroreflective condition and under the diffused light condition. Since the pattern of the region 25A of the transparent colored layer 20 and the region 45A of the opaque layer 40 is the same as that of the first embodiment, the display pattern projected on the retroreflective sheeting 1 under the diffused light conditions such as daytime is the display pattern illustrated in FIG. 4, and the display pattern projected on the retroreflective sheeting 1 under the retroreflective condition such as nighttime is the display pattern illustrated in FIG. 5.

### Third Embodiment

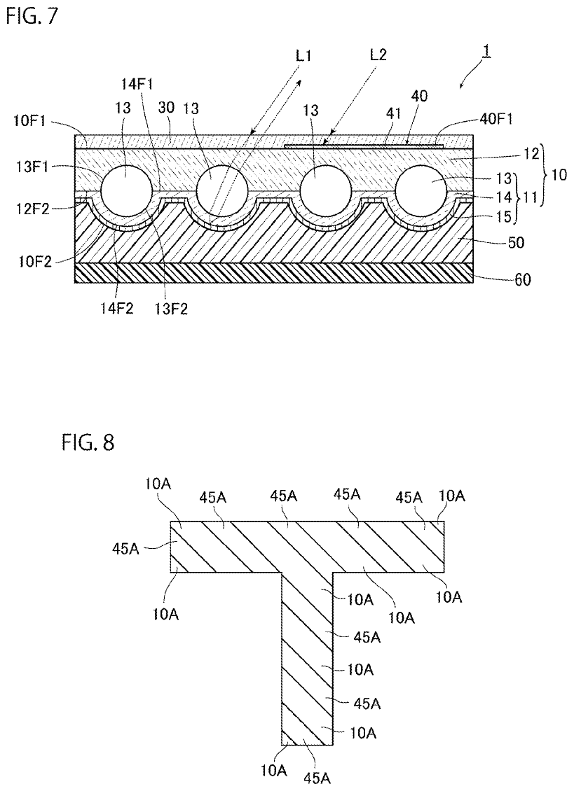

Next, a third embodiment of the present invention will be described in detail with reference to FIGS. 7 and 8. Note that the same or equivalent constituent elements as those of the first embodiment are denoted by the same reference numerals, and redundant explanation may be omitted except when particularly described.

FIG. 7 is a diagram schematically illustrating a cross section of the retroreflective sheeting 1 according to a third embodiment of the present invention. As illustrated in FIG. 7, the retroreflective sheeting 1 according to the present embodiment is different from the retroreflective sheeting 1 according to the first embodiment in not including the transparent colored layer 20. Hereinafter, the retroreflective sheeting 1 according to the present embodiment will be described.

The opaque layer 40 of the present embodiment is provided on the one surface 10F1 of the retroreflective layer 10 and faces the one surface 10F1 of the retroreflective layer 10. As in the first embodiment, the opaque layer 40 includes a plurality of band-shaped portions 41 such that a pattern in plan view has a stripe pattern. The color of the opaque layer 40 is, for example, red as in the first embodiment. The surface protective layer 30 of the present embodiment covers the entire surface of the surface 40F1 of the opaque layer 40 on the side opposite to the retroreflective layer 10 side and the entire surface of a portion of the one surface 10F1 of the retroreflective layer 10 where the opaque layer 40 is not provided. In the retroreflective layer 10 of the present embodiment, the holding body layer 12 is colored and transparent so that the hue of the entire retroreflective layer 10 when viewed from the one surface 10F1 side is equivalent to the hue of the opaque layer 40.

FIG. 8 is a view illustrating the retroreflective layer 10 and the opaque layer 40 in a direction in which one surface 10F1 of the retroreflective layer 10 is viewed in a plan view. As illustrated in FIG. 8, when viewed in this manner, the retroreflective layer 10 has a region 10A that does not overlap the plurality of band-shaped portions 41 constituting the opaque layer 40, and this region 10A is in contact with the region 45A corresponding to the band-shaped portion 41. As described above, since the hue of the opaque layer 40 is equivalent to the hue of the retroreflective layer 10 when viewed from the one surface 10F1 side, the hues of the region 10A and the region 45A are equivalent. In the present embodiment, when viewed in this manner, the entire region 45A overlaps the retroreflective layer 10, and a part of the outer edge of each region 45A overlaps a part of the outer edge of the retroreflective layer 10, and the other part overlaps other than the outer edge of the retroreflective layer 10.

In the retroreflective sheeting 1 according to the present embodiment, as described above, the hue of the retroreflective layer 10 is equivalent to the hue of the opaque layer 40. Therefore, under the diffused light condition such as daytime, in a case where the retroreflective layer 10 is viewed in a plan view, the entire region including the retroreflective layer 10 and the opaque layer 40 can be made to be viewed in the same hue as the hue of the opaque layer 40, and the opaque layer 40 and the retroreflective layer 10 can be made to appear as if integrated. Therefore, the display pattern projected on the retroreflective sheeting 1 under the diffused light condition such as daytime is the display pattern illustrated in FIG. 4 as in the first embodiment, and the display pattern that is entirely red is projected on the retroreflective sheeting 1.

In the retroreflective sheeting 1 according to the present embodiment, as described above, the hue of the region 10A of the retroreflective layer 10 is equivalent to the hue of the region 45A of the opaque layer 40. For this reason, under the diffused light condition such as daytime, the boundary between the region 10A of the retroreflective layer and the region 45A of the opaque layer 40 becomes difficult to be visually recognized, and the region 10A of the retroreflective layer 10 and the region 45A of the opaque layer 40 can be made to appear as if they are integrated. On the other hand, when the retroreflective sheeting is irradiated with light under the retroreflective condition such as nighttime, the light incident on the region 10A of the retroreflective layer 10 is retroreflected and emitted from the retroreflective sheeting 1. Most of the light incident on the opaque layer 40 is blocked by the opaque layer 40 and is not incident on the retroreflective layer 10, and is hardly retroreflected. For this reason, the region 45A of the opaque layer 40 can be made to appear darker than the region 10A of the retroreflective layer 10, and the boundary between the region 10A of the retroreflective layer 10 and the region 45A of the opaque layer 40 can be made visible. Therefore, according to the retroreflective sheeting 1 of the present embodiment, the visible display pattern represented by the retroreflective layer 10 and the opaque layer 40 can be made different between under the retroreflective condition and under the diffused light condition. Since the pattern of the region 45A of the opaque layer 40 is the same as that of the first embodiment, the display pattern projected on the retroreflective sheeting 1 under the diffused light conditions such as daytime is the display pattern illustrated in FIG. 4, and the display pattern projected on the retroreflective sheeting 1 under the retroreflective condition such as nighttime is the display pattern illustrated in FIG. 5.

The color difference between the region 10A of the retroreflective layer 10 and the region 45A of the opaque layer 40 is preferably equal to or less than 3.0, more preferably equal to or less than 2.0 when expressed by a color difference according to an L*a*b* color system defined in JIS 28730. As a result, the boundary between the region 10A of the retroreflective layer 10 and the region 45A of the opaque layer 40 can be made more difficult to visually recognize under the diffused light condition such as daytime.

In the present embodiment, as similar to the first embodiment, the opaque layer 40 includes the light diffusing agent exposed at least to the side opposite to the retroreflective layer 10 side. Therefore, the light L2 incident on the opaque layer 40 is diffused by the light diffusing agent. Accordingly, as compared with the case where the opaque layer 40 does not include the light diffusing agent, the region 45A of the opaque layer 40 can be made to appear darker under the retroreflective condition such as nighttime, and the contrast between the region 45A of the opaque layer 40 and the region 10A of the retroreflective layer 10 can be made large.

Although the present invention has been described above with the embodiments as an example, the present invention is not limited thereto.

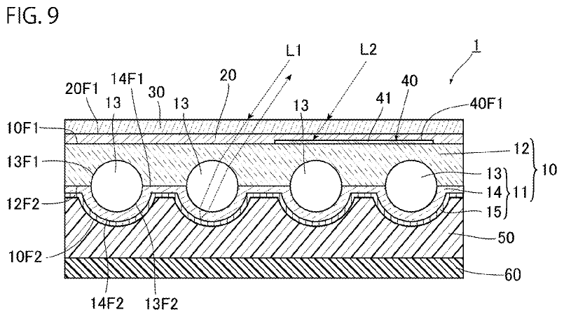

For example, in the first embodiment, the opaque layer 40 provided on the surface 20F1 of the transparent colored layer 20 on the side opposite to the retroreflective layer 10 side has been described as an example. However, the opaque layer 40 may be provided on the transparent colored layer 20 side with respect to the one surface 10F1 of the retroreflective layer 10. For example, as illustrated in FIG. 9, the opaque layer 40 may be provided between the retroreflective layer 10 and the transparent colored layer 20, and the layers may be stacked in the order of the surface protective layer 30, the transparent colored layer 20, the opaque layer 40, the retroreflective layer 10, and the adhesive layer 50. FIG. 9 is a diagram schematically illustrating a cross section of the retroreflective sheeting 1 according to a modification. Although not illustrated, for example, in the first embodiment, another opaque layer different from the opaque layer 40 may be provided between the retroreflective layer 10 and the transparent colored layer 20. In this case, the layers are stacked in the order of the surface protective layer 30, the opaque layer 40, the transparent colored layer 20, another opaque layer, the retroreflective layer 10, and the adhesive layer 50. That is, the opaque layer 40 may be provided between the retroreflective layer 10 and the transparent colored layer 20 and on the surface 20F1 of the transparent colored layer 20.

In the first and second embodiments, the transparent colored layer 20 having the region 25A whose hue is equivalent to that of the region 45A that is an entirely opaque layer 40 in a plan view of the retroreflective layer has been described as an example. However, it is sufficient that the transparent colored layer 20 has a region 25A that is in contact with the opaque layer 40 and does not overlap the opaque layer 40 in a plan view of the retroreflective layer 10, and the hue of the region 25A of the transparent colored layer 20 is equivalent to the hue of the region 45A of the opaque layer 40 in contact with the region 25A. Therefore, for example, the transparent colored layer 20 may have a plurality of regions having mutually different hues when the retroreflective layer 10 is viewed in a plan view, and the opaque layer 40 may have a plurality of regions having mutually different hues when the retroreflective layer 10 is viewed in a plan view. For example, in the second embodiment, one of the plurality of regions 25A may have a color different from red, and one of the plurality of regions 45A may have a color different from red. For example, in the second embodiment, when the retroreflective layer 10 is viewed in a plan view, a part of the band-shaped portion 41 of the opaque layer 40 and a part of the transparent colored layer 20 may overlap each other.

In the third embodiment, the description has been given by exemplifying the retroreflective layer 10 in which the holding body layer 12 of the retroreflective layer 10 is colored and transparent, and the entire hue when viewed from the one surface 10F1 side is equivalent to the hue of the opaque layer 40. However, it is sufficient that the retroreflective layer 10 has the region 10A that is in contact with the opaque layer 40 and does not overlap the opaque layer 40 in a plan view of the retroreflective layer 10, and the hue of the region 10A of the retroreflective layer 10 is equivalent to the hue of the region 45A of the opaque layer 40 in contact with the region 10A. Therefore, for example, the retroreflective layer 10 may have a plurality of regions having mutually different hues when the retroreflective layer 10 is viewed in a plan view, and the opaque layer 40 may have a plurality of regions having mutually different hues when the retroreflective layer 10 is viewed in a plan view. Examples of the configuration in which the retroreflective layer 10 has a plurality of regions having mutually different hues include a configuration in which the holding body layer 12 has a plurality of portions having mutually different colors. The holding body layer 12 of the retroreflective layer 10 may be colorless and transparent as in the first embodiment. In this case, the color of the retroreflective layer 10 when viewed from the one surface 10F1 side is a metal color corresponding to the color of the specular reflection layer 15. Therefore, for example, the color of the opaque layer 40 may be set to the same color as this metal color.

In the first and second embodiments, the example in which the surface protective layer 30 is provided has been described, but the surface protective layer 30 may be omitted. The retroreflective sheeting of the present invention may include layers other than the layers exemplified in the above embodiments.

In the first, second, and third embodiments, the example in which the retroreflective layer 10 is an enclosed lens type retroreflective layer has been described, but the retroreflective layer 10 is not limited. For example, a so-called capsule bead type, a so-called prism type, or a capsule prism type may be used.

According to the present invention, a retroreflective sheeting capable of making visible display patterns different between under a diffused light condition and under a retroreflective condition is provided, and can be used in the fields of decorative sheets, guide signs, advertisement signboards, and the like.

1. A retroreflective sheeting comprising:
a retroreflective layer that retroreflects light incident on one surface;
a light transmissive transparent colored layer provided to face the one surface of the retroreflective layer; and
a light non-transmissive opaque layer provided on a side of the transparent colored layer with reference to the one surface of the retroreflective layer,
wherein the transparent colored layer has a region that is in contact with the opaque layer and does not overlap the opaque layer when the retroreflective layer is viewed in a plan view, and
a hue of the region of the transparent colored layer is equivalent to a hue of a region of the opaque layer in contact with the region.

2. The retroreflective sheeting according to claim 1,
wherein a color difference between a color of the region of the transparent colored layer and a color of the region of the opaque layer represented by a color difference according to an L*a*b* color system defined in JIS 28730 is equal to or less than 3.0.

3. A retroreflective sheeting comprising:
a retroreflective layer that retroreflects light incident on one surface; and
a light non-transmissive opaque layer provided to face the one surface of the retroreflective layer,
wherein the retroreflective layer has a region that is in contact with the opaque layer and does not overlap the opaque layer when the retroreflective layer is viewed in a plan view, and
a hue of the region of the retroreflective layer is equivalent to a hue of a region of the opaque layer in contact with the region.

4. The retroreflective sheeting according to claim 3,
wherein a color difference between a color of the region of the retroreflective layer and a color of the region of the opaque layer represented by a color difference according to an L*a*b* color system defined in JIS 28730 is equal to or less than 3.0.

5. The retroreflective sheeting according to claim 1,
wherein the opaque layer includes a light diffusing agent exposed at least to a side opposite to a side of the retroreflective layer in the region.
